(19) United States
(12) Patent Application Publication
(10) Pub. No.: US 2006/0091639 A1
(43) Pub. Date: May 4, 2006

(54) Drive mechanism for pedal powered vehicles

(76) Inventor: David Dayton Dearborn, San Jose, CA (US)

Correspondence Address: SCHNECK & SCHNECK, P.O. BOX 2-E, SAN JOSE, CA, 95109-0005, US

(21) Appl. No.: 11/252,168

(22) Filed: Oct. 17, 2005

Related U.S. Application Data
(60) Provisional application No. 60/522,706, filed on Oct. 29, 2004.

(51) Int. Cl. B62M 1/02

(52) U.S. Cl. 280/260

(57) ABSTRACT

A drive mechanism for pedal powered vehicles including at least two unitary pulleys, each having at least one circular receiving groove, and a ribbed drive cord held in tension in the grooves of each of the two unitary pulleys. These pulleys may be made of plastic, as by injection molding. The pulleys may include a number of tiered circular grooves on the tiered layers of the pulley. A conventional derailleur may be used to change gears.

### CROSS-REFERENCE TO RELATED APPLICATION

This application claims priority from U.S. provisional application No. 60/522,706, filed Oct. 29, 2004.

### TECHNICAL FIELD

This invention relates to drive mechanisms for pedal powered vehicles.

### BACKGROUND

In pedal powered vehicles, a drive mechanism linked to the pedals is used to power the vehicle. This generally includes two sprockets and a chain. In most bicycles having multiple gears the chain ring gears, include a front cassette linked to the pedal and a rear cassette linked to the rear wheel. When the pedal is rotated the joined front chain ring turns, advancing the chain, which in turn rotates the rear cassette, thereby rotating the rear wheel. In a simple one-speed bicycle, a single front and rear gear are used.

FIG. 1 illustrates a typical bicycle drive assembly of a bicycle having both low and high gears. The pedal 4 is attached to a pedal crank arms 2a, 2b. Crank arm 2b is connected to front chain ring assembly 5 through bottom bracket housing 3. Crank arm 2a is attached to the largest gear of the ring assembly 5. This may be welded, bolted, riveted or otherwise attached. At the rear of the bicycle frame 1 is a rear hub 6 onto which is mounted a rear cassette assembly 7. When a chain is positioned over one of the rings of front chain ring assembly 5 and one of the log or sprocket of the cassette ring assembly 7, turning the pedal 4 will cause the chain to advance, rotating the rear hub 6 and driving the bicycle forward. A front and rear derailleur (not shown) allow a bicycle rider to change gears.

With respect to FIG. 2, the rear portion of the drive mechanism is illustrated having a hub 6 attached to a rear cassette 7. This is mounted on a bicycle frame 1 and secured by nut 50. Mounted on frame 1 is derailleur assembly 17. The rear chain ring assembly 7 includes a number of different diameter chain ring sprockets arranges with the smallest diameter ring on the outside and the largest diameter ring on the inside. The nut 50 may secure a quick release lever on the opposite side of the wheel to allow the associated bicycle rear wheel to be quickly removed, as during a tube change.

Attached to derailleur assembly 17 is a lower cage 14, which holds a guide wheel (sprocket) 15 and a jockey wheel 16. Both the guide wheel and the jockey wheel have precisely positioned teeth to receive, hold and guide the teeth on the bicycle chain. Cage 14 may pivot, allowing the chain to be held in tension.

FIG. 3 illustrates a conventional prior art bicycle chain. A link roller chain 11 includes a plurality of links comprises of a first plate 18 linked onto pins 19b, which are mounted in second plate 19a. Pins 19b extend through rollers 20. This configuration, when assembled gives the chain a uniform, segmented spacing between the rollers 20. This is a durable configuration that allows the rings and the chain to convey the driving force from the front crank to the rear wheel. The chain must be periodically cleaned and lubricated, preferably with a silicon lubricant that can reduce friction of the rollers without gumming up the rollers by attracting dust.

In modern bicycles, nearly all bicycle drive mechanism component parts are formed and plated metal parts. These generally require subassembly before they can be mounted on a bicycle. In addition, such parts are relatively heavy.

Although a conventional bicycle drive mechanism is highly efficient and functions well generally, it does have some shortcomings. These include the need for numerous small parts, the weight of the metal drive mechanism, and the required periodic cleaning and lubrication.

It is an object of the invention to provide a pedal powered vehicle drive mechanism that eliminates the need for a number of the presently used combination of stamped, formed, machined, cleaned, deburred, and plated metal parts, thereby reducing both cost and required weight of the drive mechanism. It is a further object to provide such a drive mechanism that does not require a chain and sprocket components, a V-belt drive system, machined or cast pulleys, and does not require a shaft drive connection between the pedals and rear wheel. It is a further object of the invention to provide an improved bicycle drive mechanism that does not require redesigning, modifying, or dismantling the current convention bicycle frame designs, and may easily be adapted to conventional components, including hubs, cranks and derailleurs.

### SUMMARY

The above objects have been achieved through an improved drive mechanism for pedal powered vehicles. This drive mechanism includes at least two unitary pulleys each having at least one cord-receiving groove, and a ribbed cord held in tension between at least two of said pulleys. The pulleys in some embodiments are molded plastic components, which are lightweight, durable, and simple to manufacture. The grooves include a structured surface that engages the cord. The pulleys may include a plurality of tiered circular grooves having differing diameters, that function as the gears of the bicycle. For such multi-geared bicycles, the drive mechanism could also include a rear derailleur guide wheel and a jockey wheel positioned in front of and below the rear hub mounted pulley. Both the rear derailleur guide and the jockey wheel guide would each have an annular cord-receiving groove to be compatible with the ribbed cord drive.

The drive cord may include a cord coupling, to allow a length of cord to be fashioned into a continuous Loop on the bicycle or other pedal powered vehicle. This coupling may be crimped, allowing simplified final assembly on the bicycle or other pedal powered vehicle.

This drive mechanism replaces the conventional front sprocket or sprockets (i.e. the front chain ring) or chain ring assembly and the rear sprocket or sprockets (including spacers, bracket and rivets) and replaces the rear derailleur sprockets or gear wheels if present, with a unitary part that may be made of light weight molded plastic. In addition the link-pin-roller chain assembly is also replaced with a lightweight cord.

### BRIEF DESCRIPTION OF THE DRAWINGS

FIG. 1 is a top view of a prior art bicycle frame and drive mechanism.

FIG. 2 is a rear view of a prior art rear sprocket assembly including a guide wheel and jockey wheel.

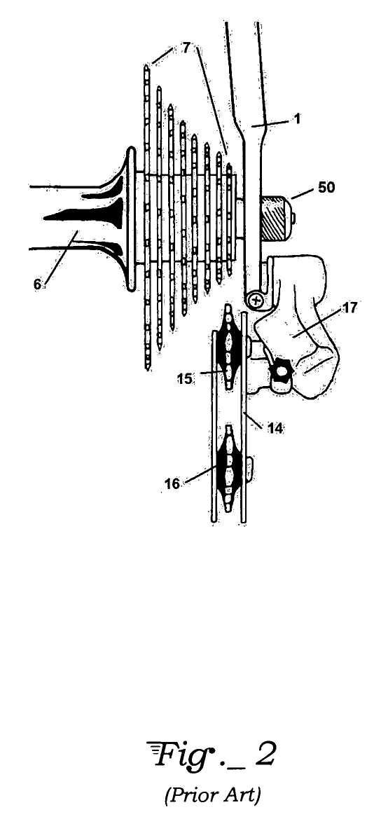

FIG. 3 is a partially exploded view of chain links in a conventional, prior art bicycle chain.

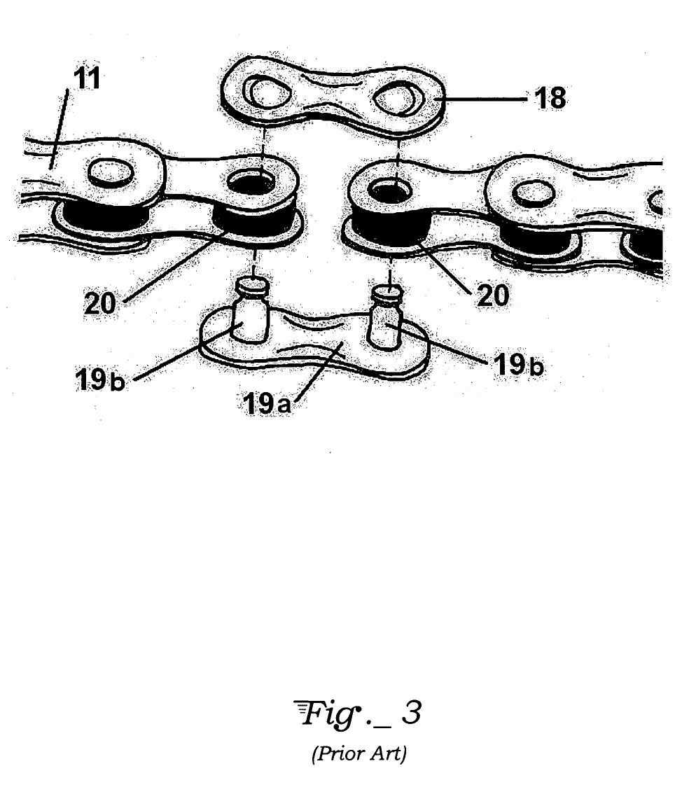

FIG. 4 is a side view of a front pulley embodiment, showing partial sections of one crank arm and of the frame.

FIG. 5 is a rear view of a rear pulley, and derailleur assembly.

FIG. 6 is a cross sectional view of a pulley.

FIG. 7 is a top view of a bicycle frame and drive mechanism, incorporating the pulleys of FIGS. 4 and 5.

FIG. 8 is a cross sectional view of a drive cord.

FIG. 9 is a side view of a drive cord of FIG. 8.

FIG. 10 is a cross-sectional view of a drive cord of FIG. 8 seated in a pulley groove.

FIG. 11 is a view of one form of a crimped cuff connecting ends of a drive cord.

FIG. 12 is a sectional side view along the long axis of an alternative cord coupling.

FIG. 13 is a sectional side view along the long axis of another alternative cord coupling.

### DETAILED DESCRIPTION

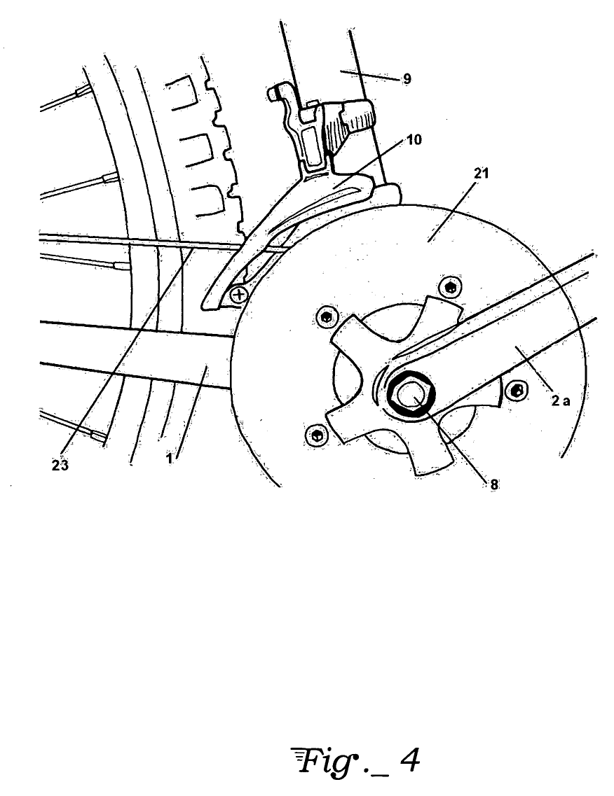

In the present invention, the front and rear sprocket assemblies, which conventionally are multipart, metal components, and/or assemblies have been replaced with a single piece part. With respect to FIG. 4, front unitary pulley 21 is mounted on crank arm 2a and crank spindle 8. Drive cord 23 extends through front derailleur and cage assembly 10, which is mounted on seat tube 9. The crank arm 2 and crank spindle 8 may be conventional bicycle parts affixed to the unitary pulley 21.

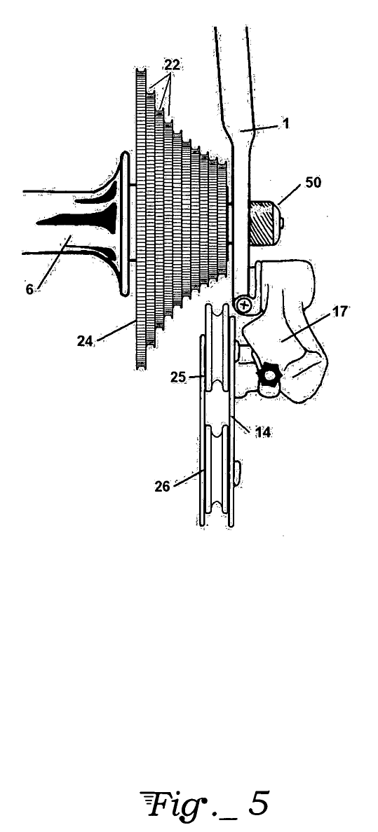

With reference to FIG. 5, the rear pulley is illustrated. As with conventional bicycles, mounted on a frame 1 is a rear hub 6 and a rear derailleur assembly 17 holding cage 14. Mounted in cage 14 are a free spinning guide pulley 25 and a free spinning jockey pulley 26. Attached to rear hub 6 is rear pulley 24. As with the front pulley, the rear pulley is comprised of a plurality of tiered circular grooves 22. The grooves include a contoured bottom and side or inner surface that may engage a cord, driving the cord forward as the pedals are turned. Rear pulley 24 may be a single piece, non-metal (e.g. plastic) molded part, having multiple tiered circular grooves 22. These grooves act as gears for the bicycle. A conventional derailleur may be used to change the cord from one groove to another, thereby altering the diameter turned by the crank. Rear derailleur cage 14 may be spring mounted, thereby holding the pulleys mounted in cage 14 such that a cord passing though these pulleys is in sufficient tension that the cord does not slip. If the cord does slip off the pulleys, a spring-loaded cage also allows the cord to be rapidly reset into a groove by providing some slack. These pulleys serve to take up the slack from rear pulley 24 as the rear pulley 24 rotates.

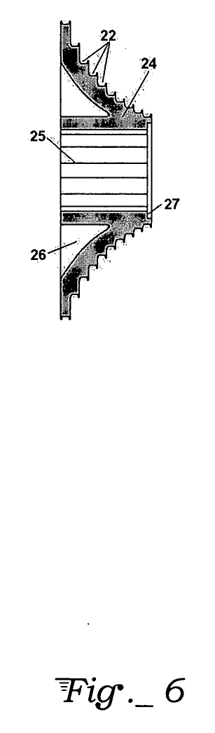

With reference to FIG. 6, the cross sectional view illustrates axial through hole 25 formed to allow the pulley 24 to be positioned over the rear wheel hub assembly, in a similar manner to the way that a conventional rear sprocket or gearing cassette is mounted. A shoulder 27 within the core is able to receive a mating lip of a threaded locking device (e.g. threshold fasteners) used to secure a rear gear set in conventional bicycles to the hub assembly.

In one embodiment, a relief 26 disposed in an annular ring on area of the pulley 24 facing the hub allows further weight reduction of the part while still ensuring structural strength of the part. As before, grooves 22 include interior molded impressions in a pattern to allow the cord to be driven forward as the pulley 24 rotates. The pulleys may be unitary, injection molded parts. One suitable material from which these parts could be made is filled or reinforced nylon.

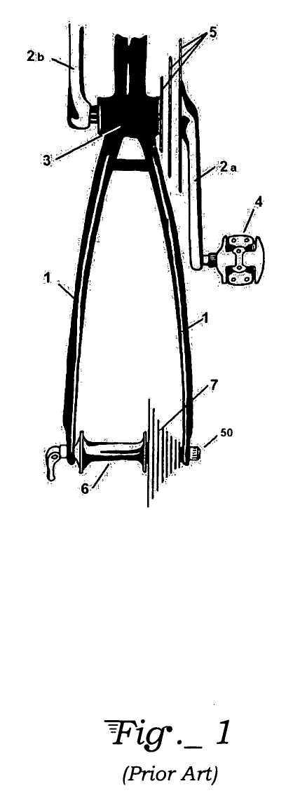

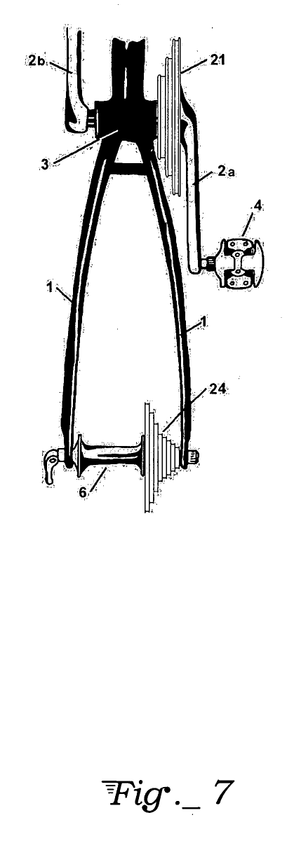

The combination of both front and rear pulleys is shown in FIG. 7. In this view, as with FIG. 1, the bicycle frame 1 includes a bottom bracket housing 3. Mounted through bottom bracket housing 3 is the link between crank arms 2a&b. At the end of crank arms 2a&b are pedals 4 (one illustrated). Attached to one of crank arms 2 is front pulley 21. Mounted on hub 6 is rear pulley 24.

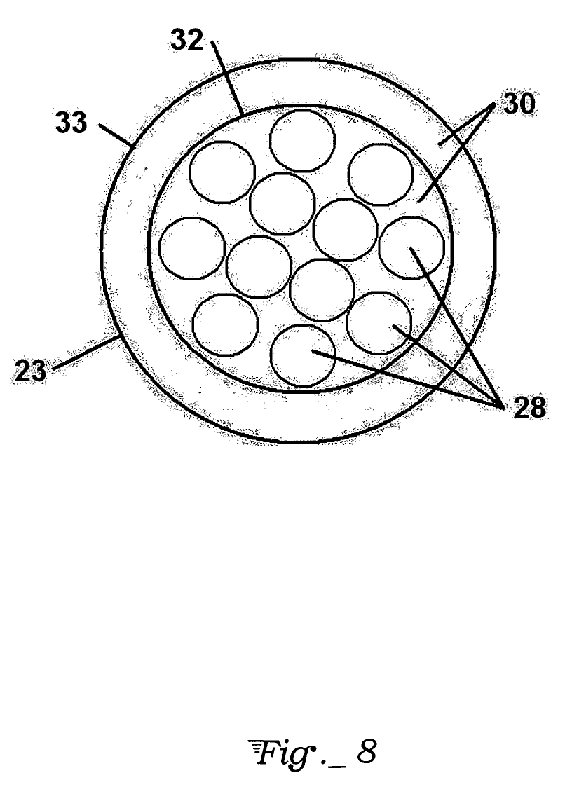

The drive cord that fits into the pulleys is retained by the textured surface within the grooves of the pulley in the illustrated embodiment. With respect to FIG. 8, the cross section of a cord 23 includes a core 28. A durable rubber-like material 30 such as polyurethane or similar material is molded in and around the core 28. Rubber material 30 forms a uniform pattern of ribs on the encapsulated woven cord material made of layers 28. This dive cord 23 could be made using materials and manufacturing processes employed in the fabrication of automotive timing belts or drive belts, flexible bead bicycle tires with durable high grip tread surfaces, or the like. The core material may be made of lightweight high tensile braided aramid, para-aramid fibers, gel spun polyethylene or a similar high tensile strength material.

The ribs are preferably evenly spaced and sufficient in number to create traction with the engaged inner surface of the pulley groove and transfer power. The size of the ribs and proportions of the ribs is designed to provide a viable combination of power transfer and size.

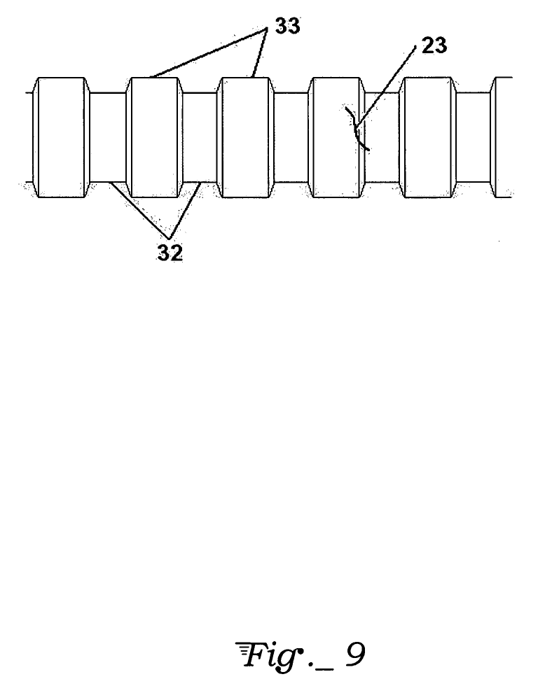

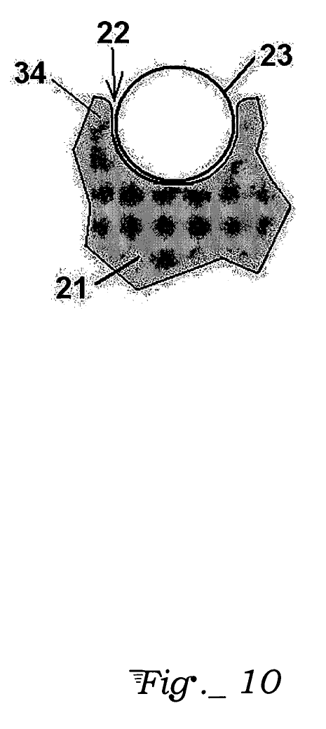

FIG. 9 shows the side view of the drive cord 23, showing the molded ribs equally spaced and of equal diameters and form, thus creating valleys 32 between ribs 33. This creates a gear like form for a mating pattern in the pulley groove. The relationship of the minor diameter at valleys 32 to the outer diameter of ribs 33, the width of the ribs and spacing of the ribs vary as required to optimize the combination of traction between the drive cord and the grooves of the pulleys and the drive cord strength. In this embodiment, the pattern of rib height, width and space between the ribs is preferably uniform and consistent for each drive cord design. In FIG. 10, the drive cord 23 is shown in a pulley groove 22 in a pulley 21.

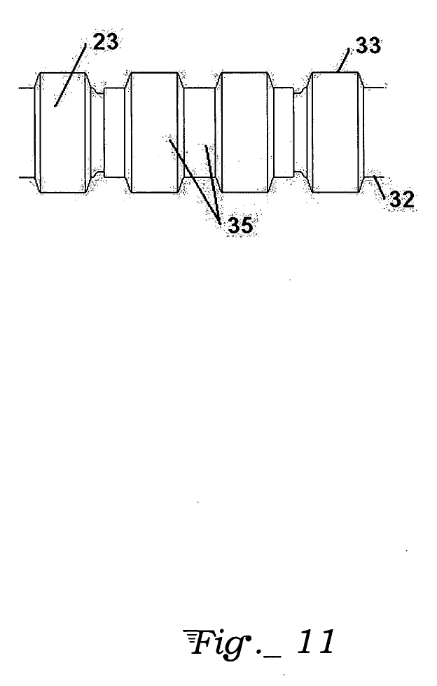

One particular technical challenge is the joining of the ends of the drive cord. In FIG. 11, one embodiment of how this would be affected is illustrated. A drive cord 23 has the ends joined by a metal cuff 35 made of a high tensile strength alloy that has been crimped on the ends of the drive cord. The ends of the drive cord are inserted into the cuff 35 and then the sleeve is crimped to form a single continuous cord. The crimping allows the sleeve to take the contour of the ribs 33 on the cord 23. The crimping of cuff 35 allows the exterior of this sleeve to form the same shape and form as the exterior of the drive cord 23. This allows the cuff 35 section to fit within reasonable tolerances into the mating groove patterns on the pulleys, as would the rest of the cord 23. In forming this cuff 35 such that it functions a coupling formed into the desired shape, cord 23 may be put under compression to allow for a more uniform final coupling region. The tool used for crimping deforms sleeve 35 to form the spaced rib pattern consistent with the rest of the drive cord if a rib pattern coupling is used. The cuff 35 is sufficiently long that at least one rib on each and is within cuff 35 prior to crimping.

Use of an epoxy, cyanoacrylate or other such high strength polymer adhesive 75 may be used in the assembly of the metal coupling and each end of the drive cord. Generally the coupling will be joined to both ends of the cord in one assembly process after drive cord is properly installed on the bicycle. The design permits the assembly of the coupling to one end prior to installation on the bicycle, and the final assembly process (coupling-to-other-end) be done after installing the cord on the bicycle or other pedal powered vehicle.

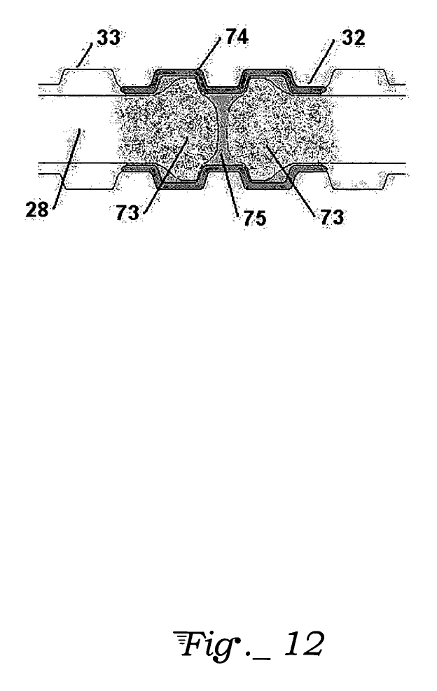

With reference to FIG. 12 an alternative coupling device 74 crimped tightly over ends of drive cord 73 at the location of ribs on the cord. At each end of the drive cord, a termination form is fabricated to provide the greatest transfer of tensile strength from the drive cord core material to the cord end and coupling assembly. Crimping coupling 74 produces essentially the same shape and profile as the exterior of the drive cord 23, and thus fits into the mating groove pattern of the front and rear pulley(s). In forming the coupling to this required shape and dimension the drive cord 23 materials may be compressed to comply with coupling design and installation requirement.

The drive cord 23 installation tool (not shown) will enable the correct position of the drive cord 23 rib 32, 33 pattern of each separate end such that when the coupling device 74 is installed, the spacing of the rib pattern on the drive cord 23 and the crimped coupling present a consistent and uniform rib-space pattern over the assembled drive cord ends. At the end of each cord the fibers comprising the core may be separated from a woven pattern. The ends could then be introduced into a metal cuff along with adhesive. The space within the cuff would be filled with a strong, durable polymer adhesive 75 and cured after crimping. Excess adhesive would be removed if needed.

The cord of FIG. 12 may be manufactured by a number of methods. One method would be to mold the rubber or rubber-like polyurethane material 30 into and onto lengths of braided cord 28 after creating the termination form 73 on each end of the braided fiber core length using high strength polymer adhesive most appropriate for creating both maximum adhesion to the cord fibers and strength of the final composite form. Assembly of the molded drive cord into one continuous length on the pedal powered vehicle would be accomplished using the metal sleeve or coupling 74, a high strength rapid curing polymer adhesive 75 and crimping tool designed to produce the desired final coupling form.

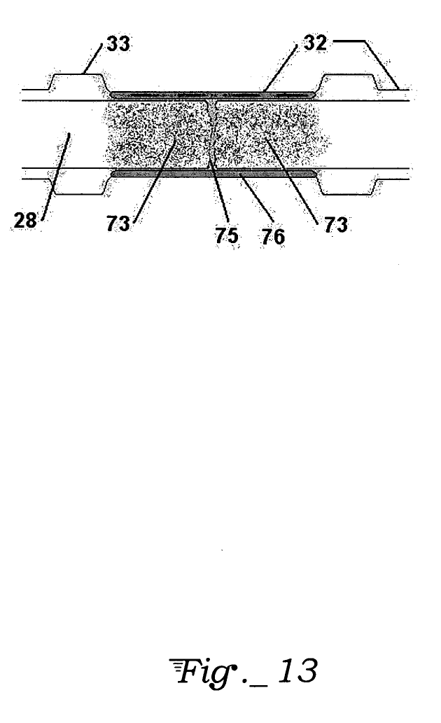

Another alternative is illustrated in FIG. 13. In this embodiment the method of terminating the drive cord core material 28 is similar to that discussed above but form of this coupling or sleeve 76 is designed to match that of the minor diameter or valleys 32 of the molded drive cord.

The illustrated embodiments replace a gear cassette with a unitary, light weight piece in the front and rear. The metal chain is replaced with a cord. This change eliminates parts, reduces the weight of the drive mechanism, and eliminates the need for periodic lubrication.

In the illustrated embodiment, the front and rear pulleys have tiered structures. It is also possible to have a “one speed” bicycle without such tiered structures.

The textured cord conforms to the groove inner surface, to engage the cord and transfer the force from the crank arm to the cord, to the rear pulley and to the rear wheel.

The construction of the front and rear pulleys allow these components to replace a conventional chain ring assembly in the front and rear. The components in this invention mount in the same manner as the parts they are replacing. With a fairly minor change in the design (variation) of these parts could be used to modify existing bicycles and other pedal powered, chain driven vehicles.

What is claimed is:

1. A drive mechanism for a pedal powered device comprising:
at least two unitary pulleys, each having at least one cord receiving groove; and
a ribbed drive cord held in tension between at least to of said pulleys.

2. The drive mechanism of claim 1, wherein said unitary pulleys are made of molded plastic.

3. The drive mechanism of claim 1, wherein said unitary pulleys each include a plurality of tiered circular grooves of differing diameters.

4. The drive mechanism of claim 1, wherein said at least to unitary pulleys includes a rear derailleur guide and a jockey wheel, each having a cord receiving groove

5. The drive mechanism of claim 1, wherein said ribbed drive cord includes a drive cord coupling.

6. The drive mechanism of claim 5, wherein said coupling is crimped.

7. A bicycle drive mechanism comprising:
a front one-piece unitary molded pulley having a plurality of tiered circular grooves;
a rear one-piece unitary molded pulley having a plurality of tiered circular grooves;
a rear derailleur guide having a circular groove;
a jockey wheel having a circular groove; and
a ribbed drive cord held in tension between said front pulley, said rear pulley, said rear derailleur guide, and said jockey wheel and movable between circular grooves in said first plurality of tiered circular grooves and said second plurality of tiered circular grooves.

8. The device of claim 7, wherein said ribbed drive cord includes a drive cord coupling.

9. The device of claim 8, wherein said drive cord coupling is crimped.
